(19) United States
(12) Patent Application Publication
(10) Pub. No.: US 2025/0199662 A1
(43) Pub. Date: Jun. 19, 2025

(54) INTERACTION METHOD AND ELECTRONIC DEVICE

(71) Applicant: Lenovo (Beijing) Limited, Beijing (CN)

(72) Inventors: Xi WAN, Beijing (CN); Yuanyuan DENG, Beijing (CN)

(21) Appl. No.: 18/981,420

(22) Filed: Dec. 13, 2024

(30) Foreign Application Priority Data
Dec. 14, 2023 (CN) 202311721433.1

(51) Int. Cl. G06F 3/0484

(52) U.S. Cl. CPC G06F 3/0484

(57) ABSTRACT

An interaction method includes responding to an input through a first window of an object configured to provide a dialogue service to obtain a first content, obtaining a target event for the first content, obtaining a second content based on the target event and the first content, expanding a second window in the object, and outputting the second content in the second window.

### CROSS-REFERENCE TO RELATED APPLICATION

This application claims priority to Chinese Patent Application No. 202311721433.1, filed on Dec. 14, 2023, the entire content of which is incorporated herein by reference.

### TECHNICAL FIELD

The present disclosure generally relates to the field of computer technologies and, more particularly, to an interaction method and an electronic device.

### BACKGROUND

Currently, artificial intelligence technology can provide users with interactive functions to solve problems or provide entertainment. However, the above interactive functions still need to be improved.

### SUMMARY

In accordance with the present disclosure, there is provided an interaction method including responding to an input through a first window of an object configured to provide a dialogue service to obtain a first content, obtaining a target event for the first content, obtaining a second content based on the target event and the first content, expanding a second window in the object, and outputting the second content in the second window.

Also in accordance with the present disclosure, there is provided an electronic device including a memory storing at least one instruction set and a processor configured to execute the at least one instruction set to respond to an input through a first window of an object configured to provide a dialogue service to obtain a first content, obtain a target event for the first content, obtain a second content based on the target event and the first content, expand a second window in the object, and output the second content in the second window.

### BRIEF DESCRIPTION OF THE DRAWINGS

FIG. 1 is a flowchart of an interaction method consistent with the present disclosure.

FIG. 2 is a flowchart of another interaction method consistent with the present disclosure.

FIG. 3 is a flowchart of another interaction method consistent with the present disclosure.

FIG. 4 is a schematic diagram showing an application scenario of an interaction method consistent with the present disclosure.

FIG. 5 is a schematic diagram showing another application scenario of an interaction method consistent with the present disclosure.

FIG. 6 is a schematic diagram showing another application scenario of an interaction method consistent with the present disclosure.

FIG. 7 is a schematic diagram showing another application scenario of an

interaction method consistent with the present disclosure.

FIG. 8 is a schematic diagram showing another application scenario of an interaction method consistent with the present disclosure.

FIG. 9 is a schematic diagram showing another application scenario of an interaction method consistent with the present disclosure.

FIG. 10 is a schematic diagram showing another application scenario of an interaction method consistent with the present disclosure.

FIG. 11 is a flowchart of another interaction method consistent with the present disclosure.

FIG. 12 is a flowchart of another interaction method consistent with the present disclosure.

FIG. 13 is a schematic structural diagram of an electronic device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

To make the above-mentioned purposes, features and advantages of the present disclosure more obvious and easier to understand, the present disclosure will be further described in detail below in conjunction with the accompanying drawings and specific implementation embodiments.

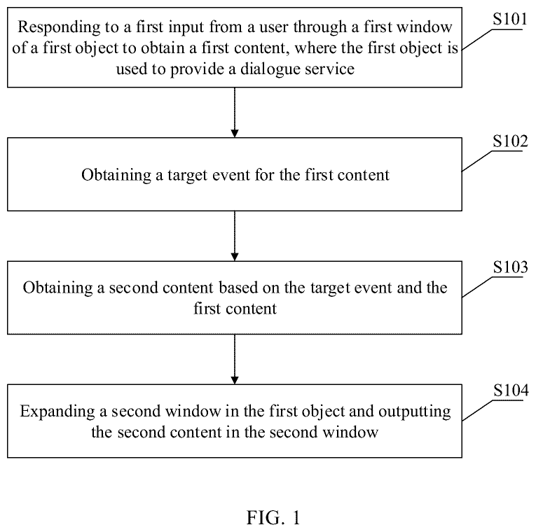

The present disclosure provides an interaction method. In one embodiment shown in FIG. 1, which is a flow chart of an interaction method consistent with the present disclosure, the method may be applied to an electronic device. The present disclosure does not limit the product type of the electronic device. The method includes, but is not limited to S101 to S104.

At S101, a first input of a user is responded to through a first window of a first object, to obtain a first content, where the first object is used to provide a dialogue service.

In one embodiment, the first object may be able to answer questions, chat and communicate, or perform file management, etc. The type of the first object is not limited in the present disclosure. For example, in one embodiment, the first object may be, but is not limited to: a functional module that is developed based on artificial intelligence technology in an application and is used by the user in the application. In another embodiment, the first object may be but is not limited to: an application that is developed based on artificial intelligence technology (such as an intelligent virtual assistant) and is used by the user.

The first window of the first object may receive the first input of the user. The first input of the user may include at least one of voice, text, or image, which is not limited in the present disclosure.

When the first window receives the first input of the user, the first object may be configured to, but is not limited to: respond to the first input of the user, identify the context information corresponding to the first input in the first window, and obtain the first content based on the context information and the first input.

The first object may choose whether to display the first content, the notification message for prompting that the first content is being obtained, or the first reply to the first input, in the first window as needed. The first reply may be used to prompt that the first content is being obtained.

At S102, a target event for the first content is obtained.

The target event for the first content may be used to prepare the first object to expand a second window. The second window may be used to assist the first window in display.

At S103, a second content is obtained based on the target event and the first content.

In one embodiment, corresponding to the target event, the first content and the second content may be completely different. In some other embodiments, the first content and the second content may also have differences from each other, but they may not be completely different.

At S104, the second window is expanded in the first object, and the second content is output in the second window.

The way to expand the second window is not limited in the present disclosure. For example, in one embodiment, the second window may be used as a side window of the first window, sliding out from the first window to expand the second window in the first object.

Outputting the second content in the second window may assist the first window in displaying.

In this embodiment, the first input of the user may be responded to through the first window of the first object, to obtain the first content. Then the target event for the first content may be obtained. The second content may be obtained based on the target event and the first content. The second window may be expanded in the first object and the second content may be output in the second window, to assist the first window in displaying based on the second window in the first object. Therefore, the interaction mode and the user experience may be improved.

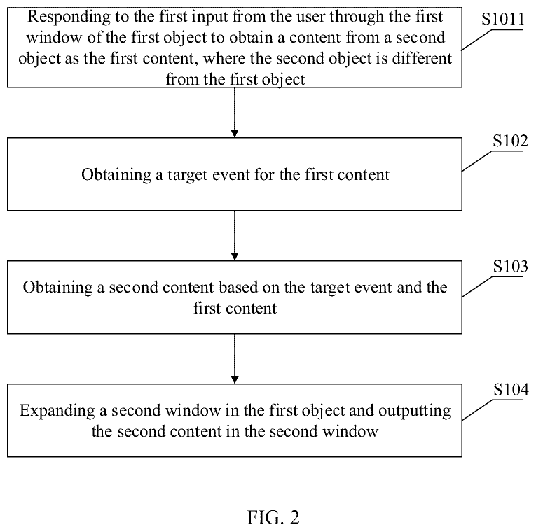

In another embodiment shown in FIG. 2, which is a flow chart of another interaction method consistent with the present disclosure, S101 includes, but is not limited to:

S1011: responding to the first input of the user through the first window of the first object to obtain a content from the second object as the first content, where the second object is different from the first object.

The first input of the user may be used to enable the first object to interact with the second object.

The first object may, but is not limited to, respond to the first input of the user, identify the use intention of the first input, interact with the second object based on the use intention, and obtain the content from the second object by interacting with the second object. For example, when the user enters “conduct meeting transcription” in the first window of the first object, the first object may identify the use intention of “conduct meeting transcription,” and determine that the use intention is not to limit interaction condition. The first object may interact with the meeting software (i.e., a specific implementation of the second object) regardless of whether the user is in the set area of the electronic device (e.g., the user is next to the electronic device or not, and the first object interacts with the meeting software). Although the first object interacts with the meeting software, the first object does not have to obtain all the data of the meeting software, as long as the meeting software generates content that needs to be transcribed, the content generated by the meeting software that needs to be transcribed may be obtained.

In another embodiment, when the user enters “conduct meeting transcription when I'm away” in the first window of the first object, the first object may identify the usage intention of “transcribe the meeting when I'm away” and determine that the usage intention is to use the user's departure as an interaction condition. The first object may interact with the meeting software to obtain the meeting software when the user is not within the set area of the electronic device. For example, the first object may determine whether the user is within the set area of the electronic device through a detection module of the electronic device, and may also determine whether the user is within the set area of the electronic device by whether a digital avatar is generated in the meeting software. When a digital avatar is generated, it may be determined that the user is not within the set area of the electronic device.

In this embodiment, the first window of the first object may be configured to respond to the user's first input, obtain the content from the second object as the first content, obtain the target event for the first content, and obtain the second content based on the target event and the first content. The second window may be expanded in the first object, and the second content may be output in the second window. Therefore, the first window in the first object may assist the first window in displaying content related to the second object based on the second window, thereby improving the interaction method. Based on the interaction between the first object and the second object, a smoother and more focused usage experience may be provided to the user in the first object.

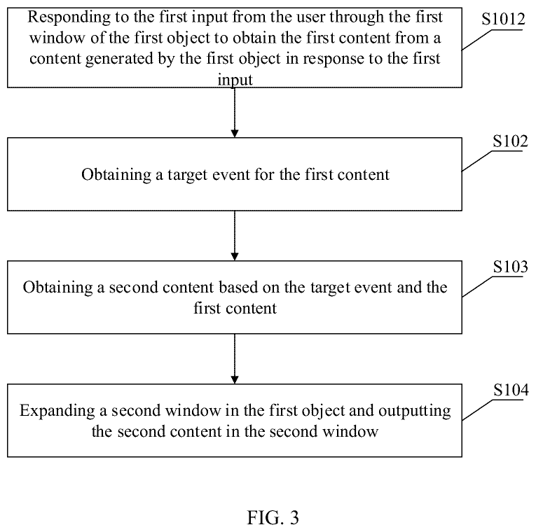

In another embodiment shown in FIG. 3, which is a flow chart of another interaction method consistent with the present disclosure, S101 includes, but is not limited to:

S1012: Responding to the first input of the user through the first window of the first object, to obtain the first content from a content generated by the first object in response to the first input.

The content generated by the first object in response to the first input may be, but is not limited to, at least one of text, voice, video, or chart.

After the first object generates the corresponding content in response to the first input, the first content may be obtained from the content generated by the first object in response to the first input.

Obtaining the first content from the content generated by the first object in response to the first input may include, but is not limited to:

S10121, obtaining description information of the second content from the second content generated by the first object in response to the first input and the description information of the second content.

The description information may include at least one of:
key content in the second content;
download entry for the second content; or
prompt information for prompting that the second content able to be previewed.

In another embodiment, S1012 may include, but is not limited to:
S10122, obtaining a portion of the content or all of the content from the content generated by the first object in response to the first input.

When the content generated by the first object in response to the first input does not meet the output condition in the first window, a portion of the content may be obtained from the content generated by the first object in response to the first input.

When the content generated by the first object in response to the first input meets the output condition in the first window, all the content may be obtained from the content generated by the first object in response to the first input.

Accordingly, the second content may come from the content generated by the first object in response to the first input and/or the new content generated by the first object based on the target event and the first content.

In this embodiment, the first window of the first object may be used to respond to the first input of the user, obtain the first content from the content generated by the first object in response to the first input, obtain the target event for the first content, and obtain the second content based on the target event and the first content. The second window in the first object may be expanded, and the second content may be output in the second window, such that the content generated by the first object is displayed in the first window based on the second window. Therefore, the interaction method may be improved, and a more smooth and concentrated use experience may be provided to the user in the first object.

In another embodiment, S102 includes, but is not limited to:

S1021: an operation event on the first content is obtained.

The operation event on the first content may include: an operation performed on the first content. For example, the operation event on the first content may be a click event, a browsing event, etc., acting on the first content.

After the first object obtains the first content, the first content may be output in the first window first, and the user may operate on the first content in the first window. Accordingly, the first object may obtain the operation event on the first content.

Corresponding to S1021, S103 may include but is not limited to: S1031, based on the operation event on the first content, the second content is obtained.

Based on the operation event on the first content, the second content associated with the first content may be obtained; or, based on the operation event on the first content, the first content may be processed to obtain the second content.

In this embodiment, the first window of the first object may be used to respond to the first input of the user, and obtain the first content. The operation event on the first content may be obtained, and the second content may be obtained based on the operation event on the first content. The second window in the first object may be expanded, and the second content may be output in the second window. Therefore, the second window may be expanded according to the operation on the first content by the user, and the first window may be assisted in displaying in the first object based on the second widow. Therefore, the interaction method may be improved, and a more smooth and concentrated use experience may be provided to the user in the first object.

In one embodiment, S102 may include but is not limited to:

S1022, obtaining a preset event for the first content.

The preset event for the first content is a pre-set event. The preset event may include but is not limited to: the proportion of the display area of the content in the area of the first window exceeds the set proportion threshold, or the type of the content is at least one of the set types.

Corresponding to S1022, S103 may include but is not limited to:

S1032, when the first content meets the preset event, obtaining the second content.

The preset event may include but is not limited to: the proportion of the display area of the content in the area of the first window exceeds the set proportion threshold, or the type of the content is at least one of the set types. S1031 may include: when the type of the first content is one of the set types and/or the proportion of the display area of the first content in the area of the first window exceeds the set proportion threshold, based on the first content, obtaining the second content.

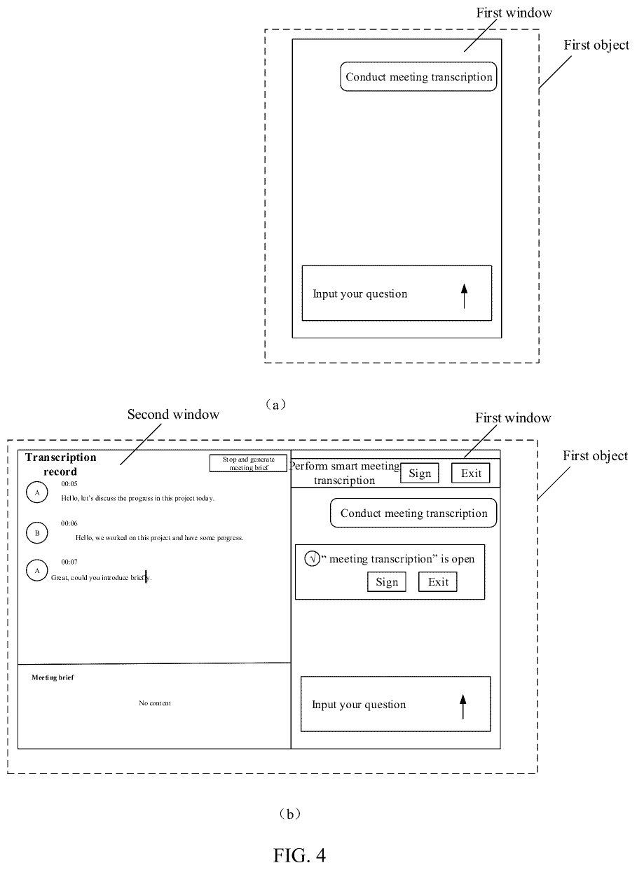

In one embodiment, based on the first content, obtaining the second content may include but is not limited to: processing the first content to obtain the second content. For example, as shown in part (a) of FIG. 4, the user enters “conduct meeting transcription” in the first window of the first object.

The first object interacts with the conference software (i.e., a specific implementation of the second object), obtains the voice of the participants in the conference software (i.e., a specific implementation of the first content), obtains the preset event for the first content as that the content type is a voice type, and transcribes the voice of the participants in the conference software when the voice of the participants in the conference software meets the voice type to obtain a transcription record (i.e., a specific implementation of the second content). As shown in part (b) of FIG. 4, during transcription, a notification message for prompting that smart transcription is in progress and a first reply to the first input are output in the first window, and the first reply is used to prompt that the conference transcription is turned on. While obtaining the transcription record, the second window is automatically expanded in the first object, and the transcription record is output in the second window. Of course, in addition to the transcription record, the second content may also include a meeting brief, an operation entry for stopping transcription and generating a meeting brief. The content of the meeting brief may be empty. When the user operates the operation entry, the first object may stop transcription and generate a meeting brief based on the transcription record, and update the content of the meeting brief in the second window. Based on outputting the second content in the second window of the first object, the first object may not interrupt the transcription of the meeting and the output of the transcription record, and the user may continue to input other content in the first window and perform other interactions with the first object, such that the user is able to obtain a smoother and more concentrated use experience.

The notification message may be displayed at the top of the first window. The viewing entrance and exit entrance may be set in both the notification message and the first reply. When the second window is accidentally closed, the user may expand the second window by operating the viewing entrance. To close and stop transcribing, the user may operate the exit entrance, stop transcribing, and close the second window.

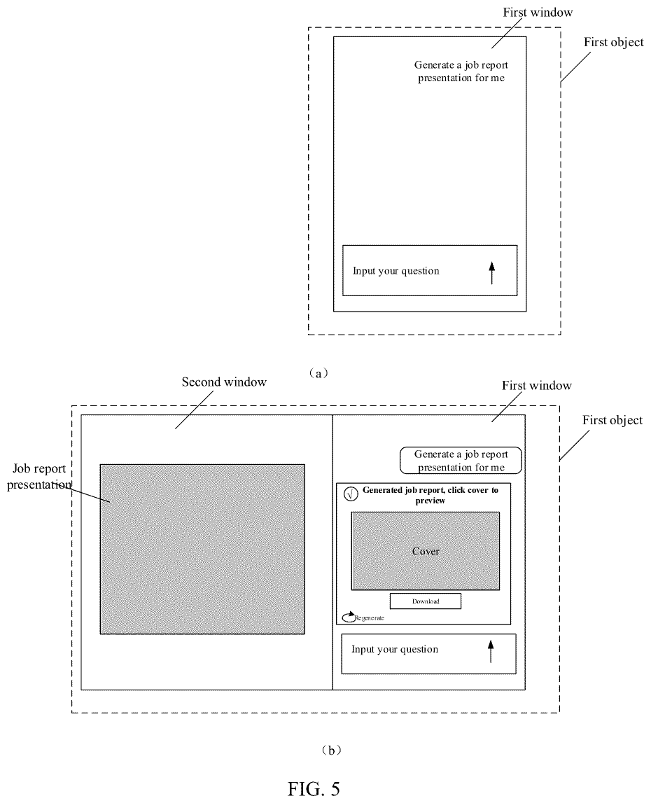

Based on the first content, obtaining the second content may also include but is not limited to: obtaining part or all of the content from the first content as the second content. For example, as shown in part (a) of FIG. 5, the user enters “help me generate a job report presentation” in the first window of the first object (i.e., a specific implementation of the first input).

In response to “help me generate a job report presentation,” the first object generates a job report presentation and the cover of the job report presentation, a download entrance, and a prompt message of “the presentation has been made for you, click on the cover to preview.” All the content may be obtained from the job report presentation and the cover of the job report presentation, the download entrance, and the prompt message of “the presentation has been made for you, click on the cover to preview” (i.e., a specific implementation of the first content). When the display area of all the contents accounts for more than a set threshold in the area of the first window, the first object may obtain the job report presentation (i.e., a specific implementation of the second content), and automatically expand the second window in the first object, as shown in part (b) of FIG. 5. The job report presentation is output in the second window, and the cover of the job report presentation, the download entrance, and a prompt message of “The presentation has been prepared for you, click on the cover to preview” may also be output in the first window.

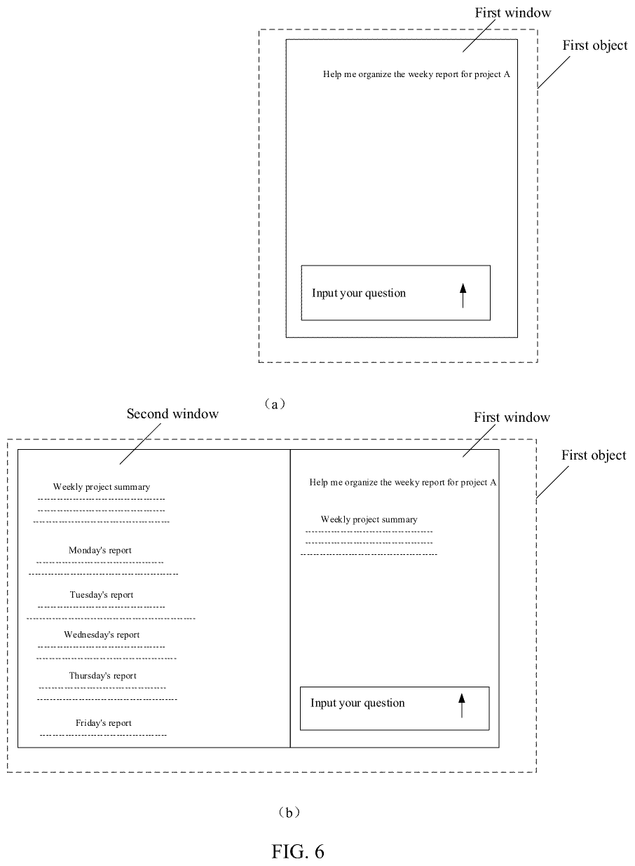

As another example, as shown in part (a) of FIG. 6, the user inputs “Help me organize the weekly report for project A” in the first window of the first object (i.e., a specific implementation of the first input).

In response to “help me organize the weekly report for project A,” the first object generates the weekly report for project A including the weekly project summary and the Monday-Friday report, and obtains the weekly project summary and the Monday-Friday report from the weekly report for project A (i.e., a specific implementation of the first content).

When the proportion of the display area of the weekly project summary and the Monday-Friday report in the area of the first window exceeds the set proportion threshold, the weekly project summary and the Monday-Friday report are used as the second content, and the second window is automatically expanded in the first object, as shown in part (b) of FIG. 6, the weekly project summary and the Monday-Friday report are displayed in the second window, and part of the content of the weekly report for project A, such as the weekly project summary, is also output in the first window.

The above implementation allows the user to browse the Monday-Friday report in the second window after browsing the weekly project summary in the first window, or directly browse the weekly project summary and Monday-Friday report in the second window, without needing to scroll or click in the first window to display the remaining content.

Of course, the key summary, chart, or reference materials in the weekly project summary and Monday-Friday report may also be used as the second content, and the second window may be automatically expanded in the first object, such that the key summary, chart, or reference materials are able to be output in the second window to improve the reading experience.

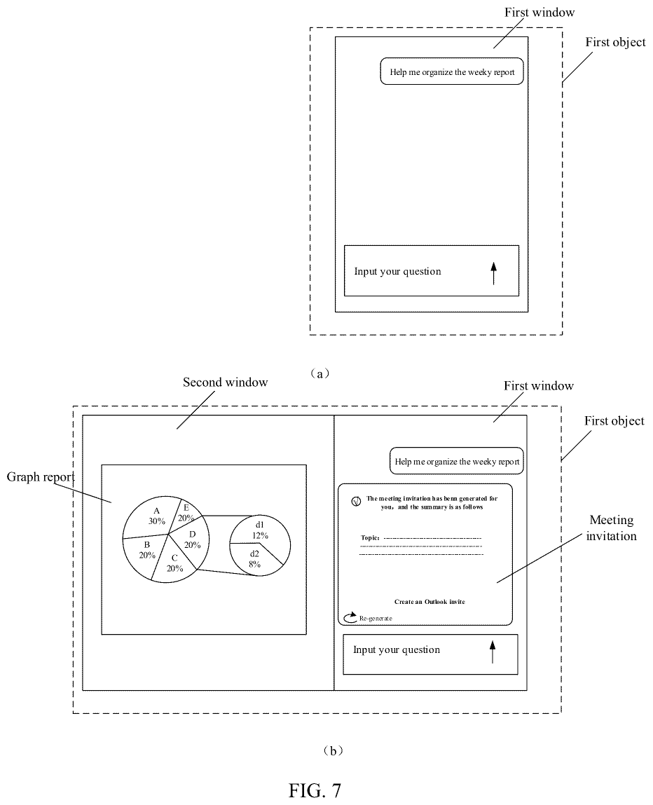

As another example, as shown in part (a) of FIG. 7, the user inputs “Help me organize the weekly report” in the first window of the first object (i.e., a specific implementation of the first input).

In response to “help me organize the weekly report,” the first object generates a report including a chart and a meeting invitation, and uses the chart and the meeting invitation as the first content. When the user operates the meeting invitation, the first object may initiate the meeting invitation as an attachment.

When the display area of the chart report and the meeting invitation exceeds the set proportion threshold in the area of the first window, the chart report is used as the second content, and the second window is automatically expanded in the first object, as shown in part (b) of FIG. 7. The chart report is output in the second window, and the meeting invitation may also be output in the first window.

In this embodiment, the first window of the first object responds to the first input of the user, obtains the first content, obtains the preset event for the first content, obtains the second content when the first content meets the preset event, expands the second window in the first object, and outputs the second content in the second window. Therefore, the second window may be automatically expanded while the second content is obtained, and the second content may be synchronously output in the second window of the first object, such that the interaction method may be improved and a more fluent and focused use experience may be provided to the user in the first object.

The detailed process of obtaining the target event for the first content in the aforementioned other embodiments may also be found in the relevant introduction of S1021 and S1022 in this embodiment, and will not be repeated here.

In another embodiment, S1031 includes, but is not limited to:

S10311: based on the operation event of the description information of the second content, obtaining the second content.

In this embodiment, the description information of the second content may be output in the first window first, and the user may operate the description information of the second content in the first window. Accordingly, the first object may obtain the second content based on the operation event of the description information of the second content. After obtaining the second content, the second window may be expanded in the first object, and the second content may be output in the second window.

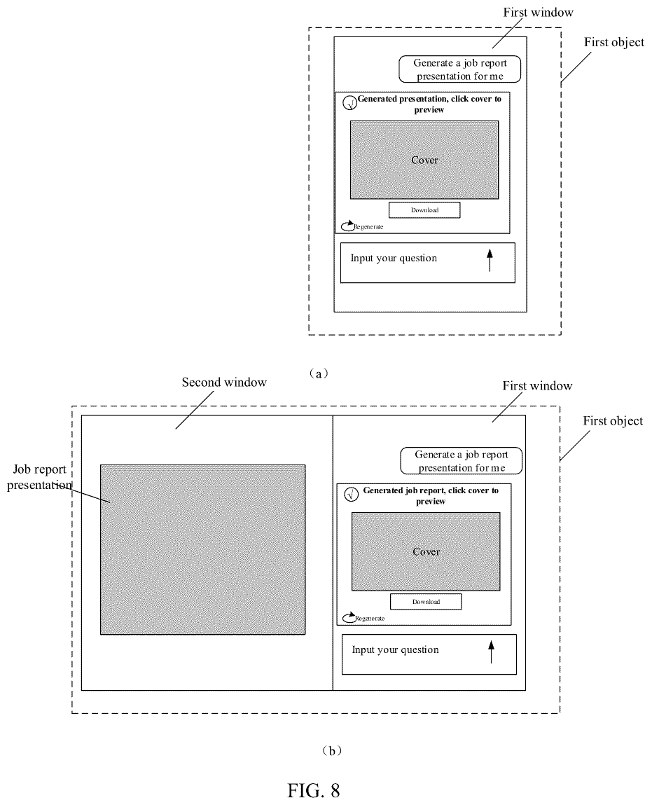

For example, as shown in part (a) of FIG. 8, the user inputs “help me generate a job report presentation” (i.e., a specific implementation of the first input) in the first window of the first object. Accordingly, in response to “help me generate a job report presentation,” the first object generates a job report presentation (i.e., a specific implementation of the second content) and the cover of the job report presentation, the download entrance and the prompt information of “The presentation has been made for you, click on the cover to preview” (a specific implementation of the description information of the second content). The first object first outputs the cover of the job report presentation, the download entrance and the prompt information of “The presentation has been made for you, click on the cover to preview” in the first window.

When the user clicks on the cover of the job report presentation, the first object may obtain a click event on the description information of the second content. Based on the click event on the description information of the second content, the first object may obtain the job report presentation, as shown in part (b) of FIG. 8, expand the second window in the first object, and output the job report presentation in the second window.

S1031 may also include but is not limited to:

S10312, based on the operation event on a part of the content, obtaining the content generated by the first object in response to the first input.

In this embodiment, a part of the content generated by the first object in response to the first input may be output in the first window first, and the user may operate on the part of the content in the first window. Accordingly, the first object may obtain the content generated by the first object in response to the first input based on the operation event on the part of the content. After obtaining the content generated by the first object in response to the first input, the second window in the first object may be expanded, and the content generated by the first object in response to the first input may be output in the second window.

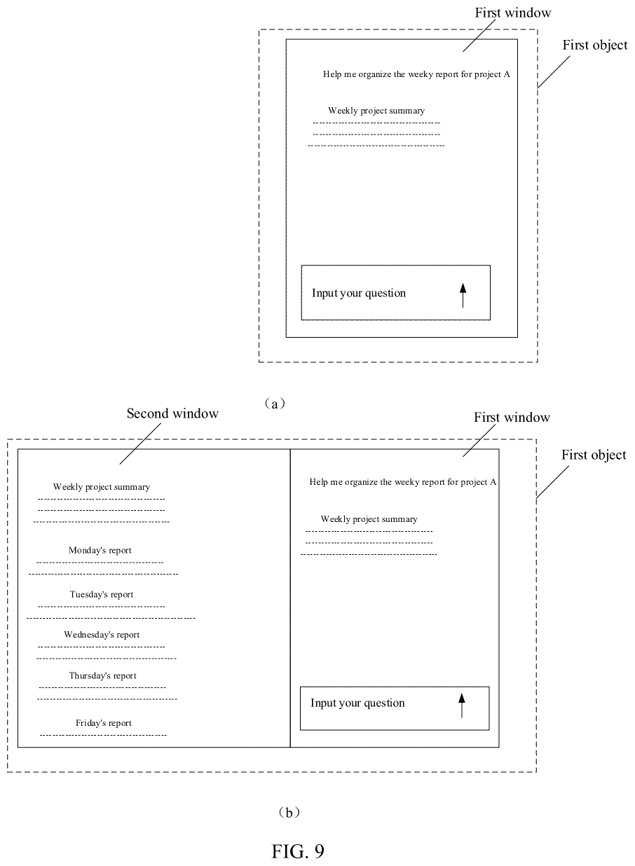

For example, as shown in part (a) of FIG. 9, the user enters “Help me organize the weekly report for project A” (i.e., a specific implementation of the first input) in the first window of the first object. Accordingly, the first object generates the weekly report for project A containing the weekly project summary and the Monday-Friday report in response to “Help me organize the weekly report for project A.” The first object obtains the weekly project summary from the weekly report for project A, and the first object first outputs the weekly project summary in the first window.

When the user scrolls or clicks on the weekly project summary in the first window, the first object may obtain a browsing event for a portion of the content. Based on the browsing event for the weekly project summary, the first object may obtain the weekly project summary and the Monday-Friday report, as shown in part (b) of FIG. 9. The second window is expanded in the first object, and the weekly project summary and the Monday-Friday report are output in the second window.

S1031 may also include but is not limited to:

S10313, based on the operation event of a part of the content or the whole content, obtaining the source information of the part of the content or the whole content.

In this embodiment, a part of the content or the whole content may be output in the first window first, and the user may operate on the part of the content or the whole content in the first window. Accordingly, the first object may obtain the source information of the part of the content or the whole content based on the operation event of the part of the content or the whole content.

A search region may be set in the first window, and a source search statement for the part of the content or the whole content may be input in the search area (i.e., a specific implementation method of the user operating the part of the content or the whole content in the first window). The first object may obtain the source information of the part of the content or the whole content according to the source search statement.

The user may also directly perform a box selection operation on the part of the content or the whole content in the first window. The first object may obtain the source information of the part of the content or the whole content according to the box selection operation (i.e., a specific implementation method of the user operating the part of the content or the whole content in the first window).

Obtaining the source information of the part of the content or the whole of the content may include but is not limited to: searching for the source of the part of the content or the whole of the content in the knowledge base of the first object to obtain the first source information; and/or searching for the source of the first part of the content or the whole of the content in the network to obtain the second source information.

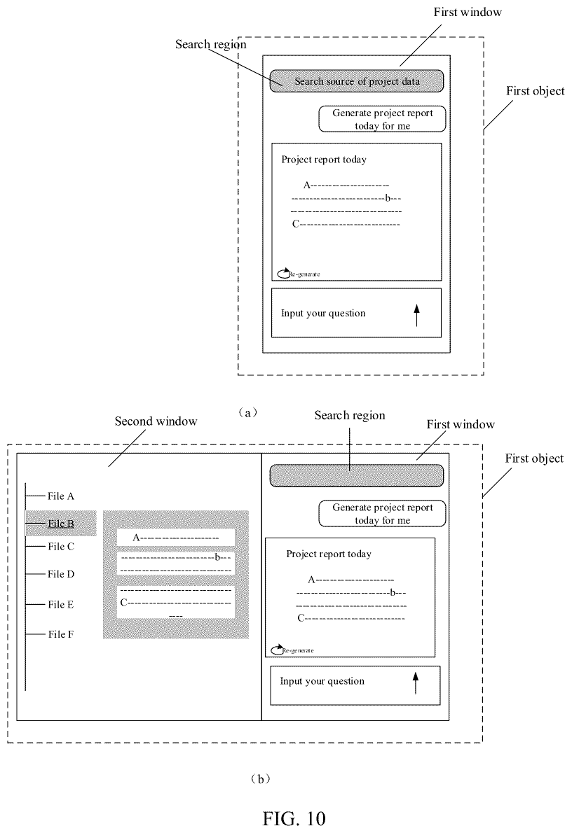

For example, as shown in part (a) of FIG. 10, the user enters “help me generate today's project report” in the first window of the first object (i.e., a specific implementation of the first input), and accordingly, the first object responds to “help me generate today's project report” and generates today's project report. The first object may enter “search for the source of project data” in the search area. In response to “search for the source of project data,” the first object searches for the project data from file B and the data containing the project data in file B in the knowledge base, as shown in part (b) of FIG. 10. The second window in the first object may be expanded, and the project data from file B and the data containing the project data in file B may be output in the second window.

Corresponding to S10313, outputting the second content in the second window may include but is not limited to:
outputting the source information of the part of the content or the whole of the content in the second window.

Of course, in another embodiment, corresponding to S10313, outputting the second content in the second window may also include but is not limited to:
highlighting the source information of the part of the content or the whole of the content in the second window.

Highlighting the source information of the part of the content or the whole of the content in the second window may include but is not limited to: displaying the source information of the part of the content or the whole of the content in at least one of a highlight flashing display mode and a set color display mode in the second window.

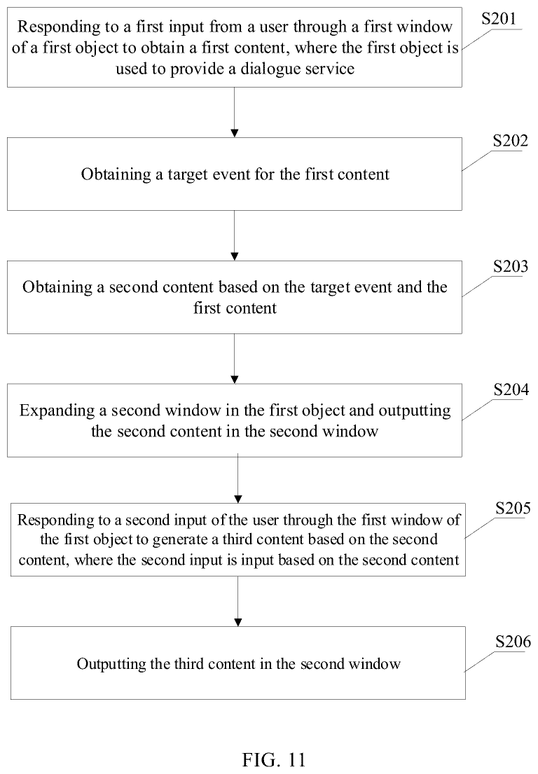

In another optional embodiment shown in FIG. 11, which is a flowchart of another interactive method consistent with the present disclosure, the method includes but is not limited to S201 to S206.

S201: responding to the first input of the user through the first window of the first object to obtain the first content, where the first object is used to provide a dialogue service;

S202: obtaining the target event for the first content;

S203: obtaining the second content based on the target event and the first content;

S204: expanding the second window in the first object and outputting the second content in the second window.

S205: responding to the second input of the user through the first window of the

first object to generate third content based on the second content, where the second input is input based on the second content; and

S206, outputting the third content in the second window.

For details of S201-S204, reference can be made to the relevant introduction in the embodiments described above, which will not be repeated here.

The second input may be input based on a part of the second content. For example, when the second content is a transcription record of a meeting and there is a content in the transcription record that requires the participants to make a job report presentation, the second input may be “help me generate a job report presentation.”

The second input may also be input based on all the content in the second content. For example, when the second content is a transcription record of a meeting, the second input may be “help me generate meeting summary.”

Generating the third content based on the second content may include but is not limited to:
obtaining key content related to the second input from the second content, and generating the third content based on the key content. For example, when the second content is a transcription record of a meeting, the second input may be “help me generate a job report presentation,” and key content related to the job report may be obtained from the transcription record of the meeting. The third content may be generated based on the key content related to the job report.

In another embodiment, generating the third content based on the second content may also include but is not limited to:
generating the third content based on all the content in the second content. For example, when the second content is a transcription record of a meeting, the second input may be “help me generate meeting summary,” and the meeting summary may be generated based on the transcription record of the meeting.

In this embodiment, the second content in the second window may be updated to the third content to output the third content in the second window.

In another embodiment, the second content and the third content may also be output simultaneously in the second window to facilitate the user to browse the second content and the third content in comparison, further improving the user experience.

In this embodiment, the first window of the first object may respond to the first input of the user, obtain the first content, obtain the target event for the first content, and obtain the second content based on the target event and the first content. The second window in the first object may be expanded, and the second content may be output in the second window, such that the first window in the first object may be assisted in displaying based on the second window in the first object. The interaction mode and the user experience may be improved.

Further, the first window of the first object may respond to the second input of the user, generate the third content based on the second content, and output the third content in the second window, therefore providing users with a smoother and more concentrated experience.

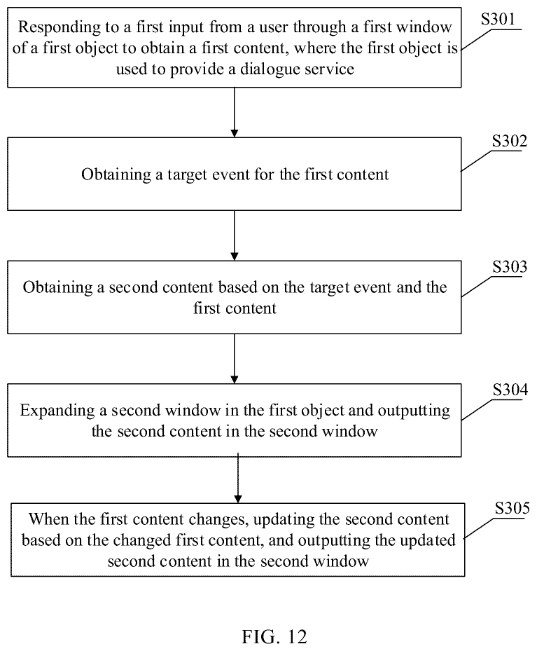

In another optional embodiment shown in FIG. 12, which is a flowchart of another interactive method consistent with the present disclosure, the method includes but is not limited to:

S301: responding to the first input of the user through the first window of the first object to obtain the first content, where the first object is used to provide a dialogue service;

S302: obtaining the target event for the first content;

S303: obtaining the second content based on the target event and the first content;

S304: expanding the second window in the first object and outputting the second content in the second window;

S305: when the first content changes, based on the changed first content, updating the second content and outputting the updated second content in the second window.

For details of S301-S304, reference can be made to the relevant introduction in the aforementioned embodiments, which will not be repeated here.

In this embodiment, there may be a new first input in the first window. The new first content may be obtained and updated. Correspondingly, updating the second content based on the changed first content may include: obtaining a new second content based on the new first content, and replacing the second content with the new second content.

It may also be that the first content changes automatically. Accordingly, updating the second content based on the changed first content may include: updating the second content based on the changed part of the first content.

In this embodiment, when the first content changes, the second content may be updated based on the changed first content. The second content may be automatically updated, and the updated second content may be output in the second window, to automatically update the output of the second window.

The present disclosure also provides an interaction device.

The interaction device may include:
a first acquisition module, configured to respond to the first input of the user

through the first window of the first object to obtain the first content, where the first object is used to provide a dialogue service;
a second acquisition module, configured to obtain the target event for the first content;
a third acquisition module, configured to obtain the second content based on the target event and the first content; and

a first output module, configured to expand the second window in the first object and output the second content in the second window.

In one embodiment, the first acquisition module may be configured to:
respond to the first input of the user through the first window of the first object to obtain the content from the second object as the first content, where the second object is different from the first object.

The first acquisition module may be configured to:
respond to the first input of the user through the first window of the first object to obtain the first content from the content generated by the first object in response to the first input.

The process of the first acquisition module obtaining the first content from the content generated by the first object in response to the first input may include:
obtaining the description information of the second content from the second content generated by the first object in response to the first input and the description information of the second content; or
obtaining a part of the content or all of the content from the content generated by the first object in response to the first input.

The second acquisition module may be configured to:
obtain an operation event for the first content; or
obtain a preset event for the first content.

The third acquisition module may be configured to:
obtain the second content based on the operation event for the description information of the second content; or
obtain the content generated by the first object in response to the first input based on the operation event for a part of the content; or
obtain the source information of a part of the content or the whole content based on the operation event for a part of the content or the whole content.

The first output module may be configured to:
highlight the source information of a part of the content or the whole content in the second window.

The interactive device may further include:
a generation module for responding to the second input of the user through the first window of the first object to generate a third content based on the second content, where the second input is input based on the second content;
a second output module for outputting the third content in the second window.

The interactive device may further include:
an update module for updating the second content based on the changed first content when the first content changes; and
a third output module may be configured to output the updated second content in the second window.

The present disclosure also provides an electronic device. Any interaction method provided by various embodiments of the present disclosure may be applied to the electronic device.

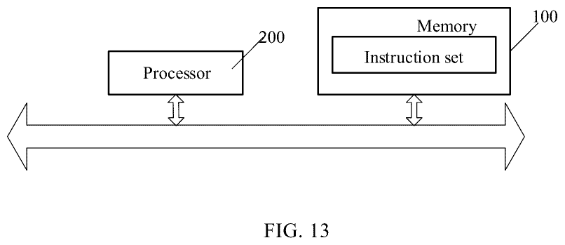

In one embodiment shown in FIG. 13, which is a structural diagram of the electronic device, the electronic device includes a memory 100 and a processor 200.

The memory 100 may be configured to store at least one instruction set.

The processor 200 may be configured to call and execute the at least one instruction set in the memory 100, to execute any interaction method provided by various embodiments of the present disclosure.

Each embodiment focuses on the differences from other embodiments, and the same or similar parts between the embodiments can be referred to each other. For the device embodiment, since it is basically similar to the method embodiment, the description is relatively simple, and for the relevant parts, reference can be made to the partial description of the method embodiment.

In the present disclosure, relational terms such as first and second, etc. are only used to distinguish one entity or operation from another entity or operation, and do not necessarily require or imply that there is any such actual relationship or order between these entities or operations. It should also be noted that in the present disclosure, the terms “include,” “comprise” or any other variant thereof are intended to cover non-exclusive inclusion, such that a process, method, article or device including a series of elements includes not only those elements, but also other elements not explicitly listed, or also includes elements inherent to such process, method, article or device. In the absence of further restrictions, an element defined by the sentence “includes one . . . ” does not exclude the presence of other identical elements in the process, method, article or device including the element.

For the convenience of description, the above device is described in various modules according to their functions. Of course, when implementing the present disclosure, the functions of each module can be implemented in the same one or more software and/or hardware.

It can be seen from the description of the above implementations that those skilled in the art can clearly understand that the present disclosure can be implemented by means of software plus a necessary general hardware platform. Based on such an understanding, the technical solution of the present disclosure essentially or partly contributed to the prior art may be implemented in the form of a software product, which can be stored in a storage medium, such as ROM/RAM, a disk, an optical disk, etc., including a number of instructions for a computer device (which can be a personal computer, a server, or a network device, etc.) to execute the methods described in each embodiment of the present disclosure or some parts of the embodiment.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An interaction method comprising:
responding to an input through a first window of an object to obtain a first content, the object being configured to provide a dialogue service;
obtaining a target event for the first content;
obtaining a second content based on the target event and the first content;
expanding a second window in the object; and
outputting the second content in the second window.

2. The interaction method according to claim 1, wherein:
the object is a first object; and
responding to the input to obtain the first content includes:
responding to the input through the first window of the first object to obtain a content from a second object as the first content, the second object being different from the first object.

3. The interaction method according to claim 1, wherein responding to the input to obtain the first content includes:
responding to the input through the first window of the object to obtain the first content from a content generated by the object in response to the input.

4. The interaction method according to claim 3, wherein obtaining the first content from the content generated by the object in response to the input includes:
obtaining description information of the second content from the second content generated by the first object in response to the first input and the description information of the second content.

5. The interaction method according to claim 3, wherein obtaining the first content from the content generated by the object in response to the input includes:
obtaining a part or a whole of the content generated by the object in response to the input.

6. The interaction method according to claim 1, wherein obtaining the target event for the first content includes:
obtaining an operation event for the first content.

7. The interaction method according to claim 6, wherein obtaining the second content based on the target event and the first content includes:
obtaining the second content based on the operation event for description information of the second content.

8. The interaction method according to claim 6, wherein obtaining the second content based on the target event and the first content includes:
obtaining a content generated by the object in response to the input based on the operation event for a part of the content.

9. The interaction method according to claim 6, wherein obtaining the second content based on the target event and the first content includes:
obtaining source information of a part or a whole of a content generated by the object in response to the input based on the operation event on the part or the whole of the content.

10. The interaction method according to claim 9, wherein outputting the second content in the second window includes:
highlighting the source information of the part or the whole of the content in the second window.

11. The interaction method according to claim 1, wherein obtaining the target event for the first content includes:
obtaining a preset event for the first content.

12. The interaction method according to claim 1,
wherein the input is a first input;
the method further comprising:
responding to a second input through the first window of the first object to generate a third content based on the second content, the second input being input based on the second content; and
outputting the third content in the second window.

13. The interaction method according to claim 1, further comprising:
in response to the first content changing, updating the second content based on the changed first content, and outputting the updated second content in the second window.

14. An electronic device comprising:
a memory storing at least one instruction set; and
a processor configured to execute the at least one instruction set to:
respond to an input through a first window of an object to obtain a first content, the object being configured to provide a dialogue service;
obtain a target event for the first content;
obtain a second content based on the target event and the first content;
expand a second window in the object; and
output the second content in the second window.

15. The electronic device according to claim 14, wherein:
the object is a first object; and
the processor is further configured to execute the at least one interaction set to, when responding to the input to obtain the first content:
respond to the input through the first window of the first object to obtain a content from a second object as the first content, the second object being different from the first object.

16. The electronic device according to claim 14, wherein the processor is further configured to execute the at least one interaction set to, when responding to the input to obtain the first content:
respond to the input through the first window of the object to obtain the first content from a content generated by the object in response to the input.

17. The electronic device according to claim 16, wherein the processor is further configured to execute the at least one interaction set to, when obtaining the first content from the content generated by the object in response to the input:
obtain description information of the second content from the second content generated by the first object in response to the first input and the description information of the second content.

18. The electronic device according to claim 16, wherein the processor is further configured to execute the at least one interaction set to, when obtaining the first content from the content generated by the object in response to the input:
obtain a part or a whole of the content generated by the object in response to the input.

19. The electronic device according to claim 14, wherein the processor is further configured to execute the at least one interaction set to, when obtaining the target event for the first content:
obtain an operation event for the first content.

20. The electronic device according to claim 19, wherein the processor is further configured to execute the at least one interaction set to, when obtaining the second content based on the target event and the first content includes:
obtain the second content based on the operation event for description information of the second content.
